(19) United States
(12) Patent Application Publication
(10) Pub. No.: US 2017/0034409 A1
(43) Pub. Date: Feb. 2, 2017

(54) METHOD, DEVICE, AND COMPUTER-READABLE MEDIUM FOR IMAGE PHOTOGRAPHING

(71) Applicant: Xiaomi Inc., Beijing (CN)

(72) Inventors: Tao CHEN, Beijing (CN); Mingyong TANG, Beijing (CN); Huayijun LIU, Beijing (CN)

(73) Assignee: Xiaomi Inc.

(21) Appl. No.: 15/214,810

(22) Filed: Jul. 20, 2016

(30) Foreign Application Priority Data
Jul. 31, 2015 (CN) 201510463273.4

(51) Int. Cl. H04N 5/232; G06T 7/00

(52) U.S. Cl. CPC H04N 5/232; G06T 7/004

(57) ABSTRACT

Method, device and computer-readable medium for image photographing. The method includes: obtaining a preset pose for photographing; detecting whether a pose of a target object in a preview image matches the preset pose for photographing; and if the pose of the target object matches the preset pose for photographing, automatically photographing an image containing the target object.

### CROSS-REFERENCE TO RELATED APPLICATION

This application is based upon and claims priority to Chinese Patent Application No. 201510463273.4, filed on Jul. 31, 2015, the entire contents of which are incorporated herein by reference.

### TECHNICAL FIELD

The present disclosure generally relates to the field of image photographing technology and, more particularly, to method, device and computer-readable medium for image photographing.

### BACKGROUND

Recently, electronic devices with an image photographing function, such as mobile phone, camera, and smart glasses, have become one of the essential electronic products for travel.

When a user wants to photograph a selfie from certain angle, he may aim camera of an electronic product at himself, then perform the photographing. However, since the user may not be posing with the greatest satisfaction at the moment when taking the photo, he usually needs to make several attempts before obtaining the most satisfactory photo.

### SUMMARY

According to a first aspect of the present disclosure, a method for image photographing includes: obtaining a preset pose for photographing; detecting whether a pose of a target object in a preview image matches the preset pose for photographing; and if the pose of the target object matches the preset pose for photographing, automatically photographing an image containing the target object.

According to a second aspect of embodiments of the present disclosure, a device for image photographing includes: a processor; and a memory for storing instructions executable by the processor. The processor is configured to, when executing the instructions stored in the memory: obtain a preset pose for photographing; detect whether a pose of a target object in a preview image matches the preset pose for photographing; and if the pose of the target object matches the preset pose for photographing, automatically photograph an image containing the target object.

According to a third aspect of embodiments of the present disclosure, there is provided a non-transitory computer-readable storage medium having stored therein instructions that, when executed by a processor, causes the processor to perform a method for image photographing. The method includes: obtaining a preset pose for photographing; detecting whether a pose of a target object in a preview image matches the preset pose for photographing; and if the pose of the target object matches the preset pose for photographing, automatically photographing an image containing the target object.

It is to be understood that both the forgoing general description and the following detailed description are exemplary only, and are not restrictive of the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a schematic diagram illustrating the implement environment related to a method for image photographing according to some of exemplary embodiments.

FIG. 2 is a flow diagram illustrating a method for image photographing according to an exemplary embodiment.

FIG. 3A is a flow diagram illustrating a method for image photographing according to another exemplary embodiment.

FIG. 3B is a schematic diagram illustrating a preview image obtained by a photographic device according to another exemplary embodiment.

FIG. 4 is a block diagram illustrating an image photographing device according to an exemplary embodiment.

FIG. 5 is a block diagram illustrating an image photographing device according to another exemplary embodiment.

FIG. 6 is a block diagram illustrating a device for image photographing according to an exemplary embodiment.

### DETAILED DESCRIPTION

Reference will now be made in detail to exemplary embodiments, examples of which are illustrated in the accompanying drawings. The following description refers to the accompanying drawings in which same numbers in different drawings represent same or similar elements unless otherwise described. The implementations set forth in the following description of exemplary embodiments do not represent all implementations consistent with the invention. Instead, they are merely examples of devices and methods consistent with aspects related to the invention as recited in the appended claims.

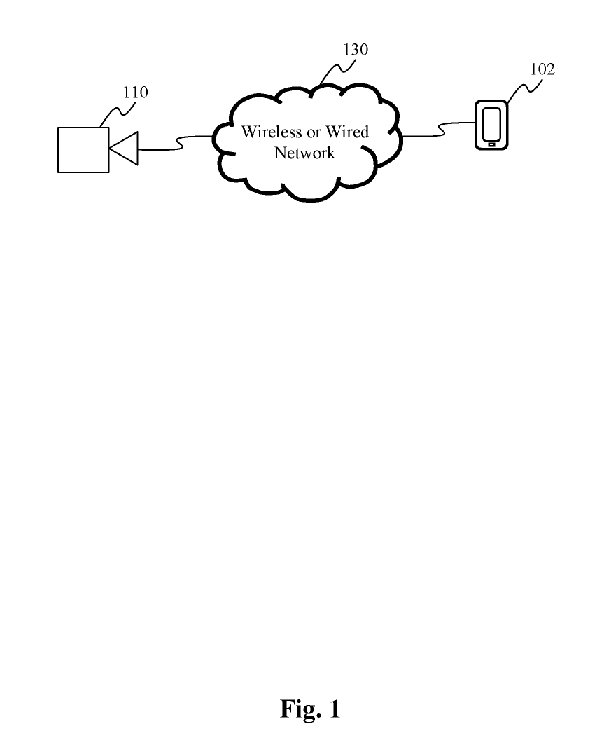

FIG. 1 illustrates a schematic diagram of an implement environment related to a method for image photographing, according to some of exemplary embodiments of the present disclosure. As illustrated in FIG. 1, the implement environment may include a photographic device 110 and a smart terminal 120.

Photographic device 110 may be a device with photographing function. Photographic device 110 may be a mobile phone, a computer including a camera, a digital camera, or a motion camera, etc. Photographic device 110 may be connected to smart terminal 120 via a wired or wireless network 130.

Smart terminal 120 may be a mobile phone, a tablet, or an e-reader.

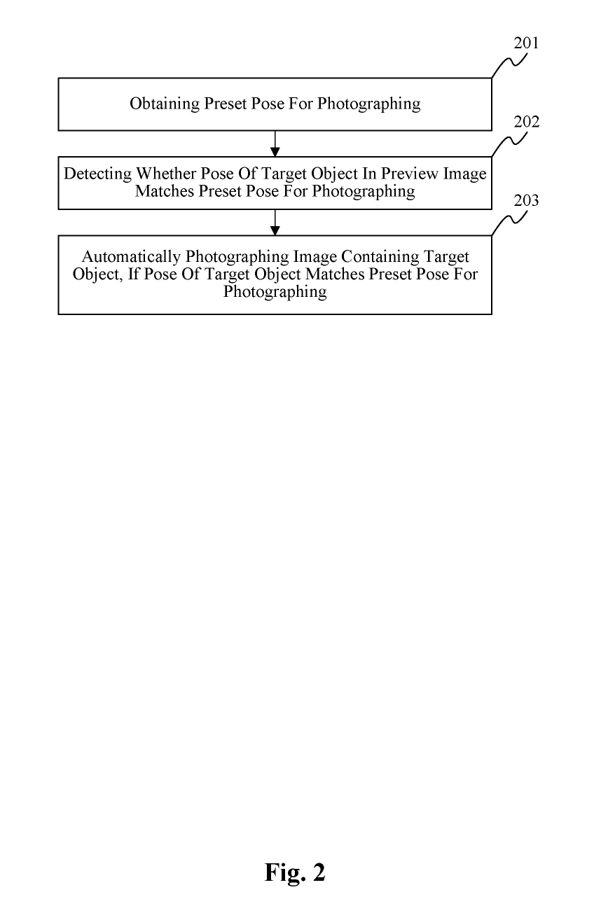

FIG. 2 is a flow diagram illustrating a method for image photographing according to an exemplary embodiment. As illustrated in FIG. 2, the method for image photographing may include the following steps.

In step 201, a preset pose for photographing is obtained.

In step 202, whether a pose of a target object in a preview image matches the preset pose for photographing is detected.

In step 203, an image containing the target object is photographed automatically, if the pose of the target object matches with the preset pose for photographing.

To sum up, the method for image photographing provided in the embodiment of the disclosure obtains the preset pose for photographing, and automatically photographs the image containing the target object if the pose of the target object in the preview image matches the preset pose for photographing. In this manner, the method can solve a problem that the user (i.e., the target object) has to make several attempts before obtaining a satisfactory image. In addition, the method can reduce the complexity of the user's operations. Meanwhile, by automatically photographing the image containing the target object, the method can solve the problem that the user's expression might be affected when he manually snaps the shutter of the photographic device.

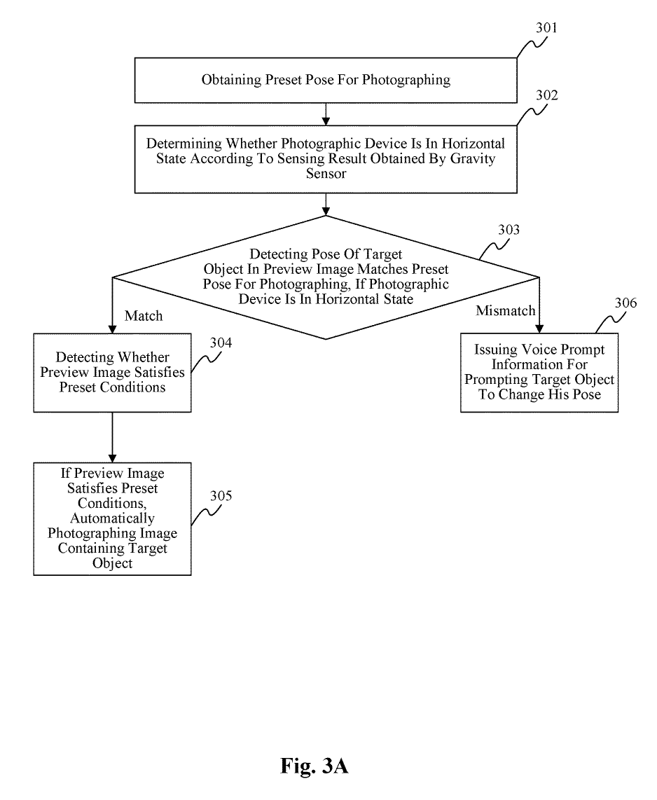

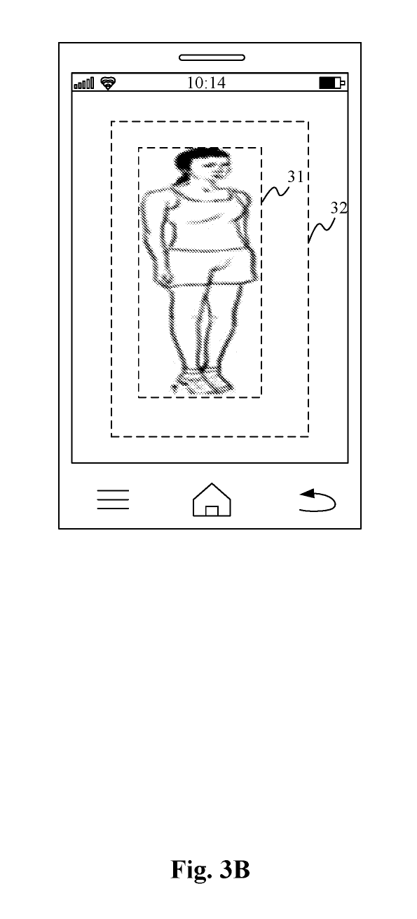

FIG. 3A is a flow diagram illustrating a method for image photographing according to an exemplary embodiment. The method is applied on a photographic device. As illustrated in FIG. 3A, the method for image photographing includes the following steps.

In step 301, a preset pose for photographing is obtained.

This step includes the following two possible implementations.

In the first implementation, a pose setting signal is received, and a pose set by the pose setting signal is taken as the preset pose for photographing.

A user may set a pose for photographing in the photographic device. Accordingly, the photographic device may receive a pose setting signal imposed by the user when setting the pose for photographing, and take the pose set by the pose setting signal as the preset pose for photographing.

In one exemplary embodiment, the photographic device may display a pose setting interface including 3D human figure model. The photographic device receives a setting signal for setting a pose of 3D human figure model imposed by the user, and determine the pose set by the setting signal as the preset pose for photographing. The user can change the pose of the 3D human figure model by sliding up-down or left-right, i.e., the photographic device may change the pose of the 3D human figure model according to the received up-down or left-right sliding signal.

For example, in the event that the photographic device is a mobile phone, when a user wants to take a photo of the right side of his body, he may apply a right-sliding signal on a 3D human figure model displayed on a pose setting interface on his mobile phone. After receiving the sliding signal, the mobile phone rotates the 3D human figure model to the right. When the 3D human figure model is rotated at a satisfactory angle, the user may stop sliding, and tap a confirmation option on the pose setting interface. After receiving the tap signal, the current pose of the 3D human figure model is determined as the preset pose for photographing.

In one exemplary embodiment, a plurality of candidate poses for photographing may be prestored in the photographic device. For example, the photographic device can prestore a plurality of figure images having different poses. When a selection signal for selecting one of the candidate poses for photographing is received, the candidate pose selected by the selection signal is taken as the preset pose for photographing.

In the second implementation, the preset pose for photographing is obtained from a smart terminal. The present pose for photographing is a pose preset in the smart terminal.

The photographic device can establish a wireless connection with the smart terminal, and then, through the wireless connection, obtain the preset pose for photographing from the smart terminal. For example, in the event that the photographic device is a motion camera, and the smart terminal is a mobile phone, the motion camera can establish a WiFi (Wireless Fidelity) connection or BLUETOOTH connection with the mobile phone, and obtain a preset pose for photographing from the mobile phone. The method for setting the preset pose for photographing in the mobile phone is similar with that in the first possible implementation, and the explained thereof is not repeated herein.

In step 302, whether the photographic device is in a horizontal state is determined according to a sensing result obtained by a gravity sensor.

In step 303, if the photographic device is in the horizontal state, whether a pose of a target object in a preview image matches the preset pose for photographing is detected.

If the photographic device is determined to be in the horizontal state currently, it means that a horizontal image photographed at this moment can be obtained, and thus a better photographic effect can be reached. Therefore, the photographic device can detect whether the pose of the target object in the preview image matches the preset pose for photographing. If matched, the method proceeds to step 304; and if not, the method proceeds to step 306. Usually, the target object is one, i.e., the method for image photographing of the present embodiment is used for photographing a single object.

In one embodiment, in step 303, the photographic device performs image recognition on the preview image to detect whether the pose of the target object in the preview image matches with the preset pose for photographing. The pose of the target object includes facing direction of the head of the target object and angle of the body of the target object.

In step 304, if the pose of the target object matches the preset pose for photographing, whether the preview image satisfies preset conditions is detected.

Preset conditions include: the proportion of the target object in the preview image being greater than or equal to a preset proportion, and/or the area occupied by the target object in the preview image being a preset area.

If the preset conditions include the proportion of target object in the preview image being greater than or equal to the preset proportion, then in the case that the photographic device detects that the pose of the target object matches the preset pose for photographing, the photographic device determines the proportion of target object in the preview image. For example, for the preview image shown in FIG. 3B, the photographic device may determine that the proportion of target object in the preview image is 2/5. Upon determining the proportion occupied by the target object, the photographic device detects if the proportion is greater than or equal to the preset proportion. For example, if the preset proportion is 1/4, then the photographic device detects whether 2/5 is greater than or equal to the preset proportion of 1/4.

If the preset conditions include the area occupied by the target object in the preview image being the preset area, then in the case that the photographic device detects that the pose of the target object matches the preset pose for photographing, the photographic device determines the area occupied by the target object in the preview image. For example, referring to FIG. 3B, the photographic device may determine that the area occupied by the target object is area 31. Upon determining the area occupied by the target object in the preview image, the photographic device detects if the area is the preset area. For example, if the preset area is area 32, then the photographic device detects whether area 31 is the preset area 32. In this embodiment, the area occupied by the target object in the preview image being the preset area means that the area occupied by the target object in the preview image is included in the preset area. For the purpose of guaranteeing the quality of the image photographed, the preset area normally is the central area of an image.

This embodiment depicts that the preset conditions include the above-mentioned two conditions only by way of illustration. In one exemplary embodiment, the preset conditions may also include other conditions, which are not limited by this embodiment.

In step 305, if the preview image satisfies the preset conditions, an image containing the target object is automatically photographed.

In one embodiment, step 305 includes the following steps.

First, photographing prompt information is sent. For example, when the photographic device detects that the preview image satisfies the preset conditions, the photographic device issues the photographing prompt information by, for example, making a ‘tick-tick’ sound. When the target object hears the ‘tick-tick’ sound, he can be aware that the photographic device is going to photograph, then he can hold his current pose and keep still.

Second, after a predetermined period of time, the image containing the target object is automatically photographed. For example, when the photographic device detects that the preview image satisfies the preset conditions, the photographic device starts a timer having the predetermined period of time. Once the predetermined period of time has lapsed, the photographic device automatically photographs the image containing the target object.

If the preview image does not satisfy the preset conditions, the photographic device returns to step 302 until the photographic device finds a preview image that satisfies the preset conditions, the description of which will not be repeated herein.

In step 306, if the pose of the target object mismatches the preset pose for photographing, then voice prompt information is sent, which is used for prompting the target object to change his pose.

In this case, in order to photograph an image containing the pose the user expected, the photographic device issues voice prompt information, which is used for prompting the target object to change his pose. For example, the photographic device can play a voice message “please change your pose”.

In the method of the present embodiment, step 302 and 304 are optional. For example, when implementing the method of the present embodiment in practice, step 303 can be executed directly after step 301 without executing step 302, and when detecting the pose of the target object matches the preset pose for photographing, step 305 may be executed directly after step 303 without executing step 304. In addition, this embodiment only takes the order of execution of steps 302, 303, and 304 as an example, and alternatively, they may be executed in any order without limitation of this embodiment.

In one application scenarios of the embodiment, the user can connect his motion camera with his mobile phone and preset the pose he wants to be photographed in the mobile phone, and then the mobile phone can provide the preset pose to the motion camera. Subsequently, upon the motion camera detecting that the pose of the user in the preview image matches the preset pose, and the proportion of the user in the preview image and/or the area occupied by the user in the preview image satisfies the conditions, the motion camera can automatically photograph an image of the user. In one embodiment, before the motion camera performs the operation of photographing, the motion camera further detects whether the motion camera itself is in a horizontal state, and performs the operation of photographing only if it is in the horizontal state, thereby improving the quality of the image photographed.

To sum up, the method for image photographing provided in the embodiment of the disclosure obtains the preset pose for photographing, and automatically photographs the image containing the target object if the pose of the target object in the preview image matches the preset pose for photographing. In this manner, the method can solve a problem that the user (i.e., the target object) has to make several attempts before obtaining a satisfactory image. In addition, the method can reduce the complexity of the user's operations. Meanwhile, by automatically photographing an image containing the target object, the method can solve the problem that the user's expression and pose might be affected when he manually snaps the shutter of the photographic device when manually photographing an image.

Moreover, by detecting if the photographic device is in the horizontal state, the method can solve the problem that, when the photographic device is tilted, the image photographed by the photographic device is also tiled.

The embodiment only performs the photographing when the preview image meets the preset conditions, thus avoids the problem that the quality of the image photographed by the photographic device in case of the target object in the preview image being too small or the target object being on edge of the preview image, and improves the quality of the image photographed.

When the photographic device is photographing, it can issue photographing prompt information. When the user (i.e., the target object) is aware of the photographing prompt information, he can keep still and hold the current pose, ensuring that the photographic device can take an image expected by the user.

Meanwhile, when the photographic device detects that the pose of the target object mismatches the preset pose for photographing, it can issue voice prompt information to prompt the target object to change his pose, ensuring that the photographic device can quickly take an image containing the pose expected by the user.

The following description relates to the device embodiments of the disclosure. For details undisclosed by the device embodiments of the disclosure, please refer to the method embodiments of the disclosure.

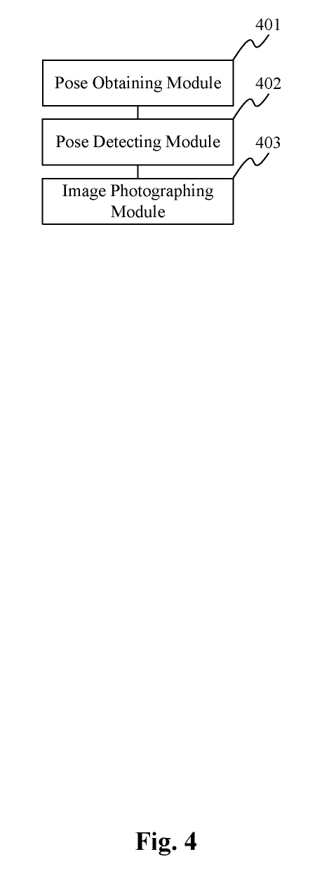

FIG. 4 is a block diagram illustrating a device for image photographing according to an exemplary embodiment. The device for image photographing can be applied on a photographic device. As shown in FIG. 4, the device for image photographing includes, but not limited to: pose obtaining module 401, pose detecting module 402, and image photographing module 403.

Pose obtaining module 401 is configured to obtain a preset pose for photographing.

Pose detecting module 402 is configured to detect if a pose of a target object in a preview image matches the preset pose for photographing obtained by the pose obtaining module 401.

Image photographing module 403 is configured to automatically photograph an image containing the target object, if the pose of the target object matches the preset pose for photographing.

To sum up, the device for image photographing provided in the embodiments of the disclosure obtains the preset pose for photographing, and automatically photographs the image containing the target object when the pose of the target object in the preview image matches the preset pose for photographing. In this manner, the device can solve the problem that the user (i.e., the target object) needs to make several attempts before taking a satisfactory image, In addition, the device can reduce the complexity of the user's operations.

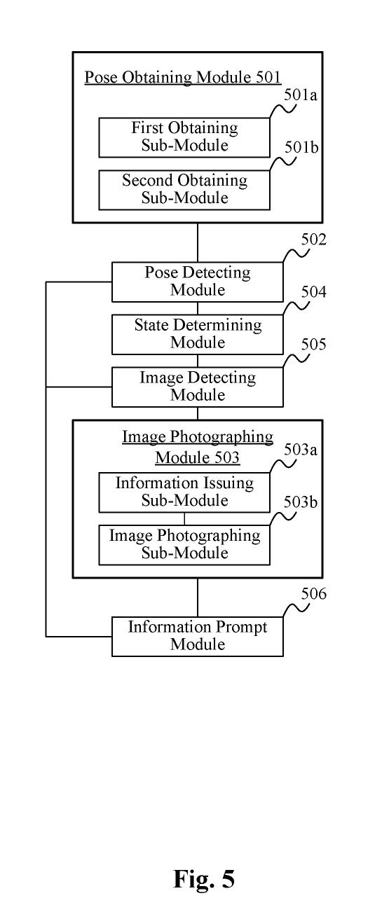

FIG. 5 is a block diagram illustrating a device for image photographing according to an exemplary embodiment. As shown in FIG. 5, the device for image photographing includes, but not limited to: a pose obtaining module 501, a pose detecting module 502, and an image photographing module 503.

Pose obtaining module 501 is configured to obtain a preset pose for photographing.

Pose detecting module 502 is configured to detect if a pose of a target object in a preview image matches the preset pose for photographing obtained by the pose obtaining module 501.

Image photographing module 503 is configured to automatically photograph an image containing the target object, if the pose of the target object matches the preset pose for photographing.

In one embodiment, the pose obtaining module 501 includes: a first obtaining sub-module 501a, configured to receive a pose setting signal, and take a pose set by the pose setting signal as the preset pose for photographing; or a second obtaining sub-module 501b, configured to obtain the preset pose for photographing from a smart terminal, wherein the preset pose for photographing is a pose preset in the smart terminal.

In one embodiment, the device further includes: a state determining module 504, configured to determine whether the photographic device is in a horizontal state according to a sensing result obtained by a gravity sensor. In this embodiment, the image photographing module 503 is configured to perform the operation of automatically photographing the image containing the target object when the state determining module 504 determines that the photographic device is in the horizontal state.

In one embodiment, the device further includes: an image detecting module 505, configured to detect if the preview image satisfies preset conditions. The preset conditions include: the proportion of the target object in the preview image being greater than or equal to a preset proportion, and/or the area occupied by the target object in the preview image being a preset area. In this embodiment, the image photographing module 503 is configured to perform the operation of automatically photographing the image containing the target object when the image detecting module 505 detects that the preview image satisfies the preset conditions.

In one embodiment, image photographing module 503 includes: an information issuing sub-module 503a, configured to issue photographing prompt information; and an image photographing sub-module 503b, configured to automatically photograph the image containing the target object, when a predetermined period of time has lapsed.

In one embodiment, the device further includes: an information prompt module 506, configured to send voice prompt information when the pose of the target object mismatches the preset pose for photographing, for prompting the target object to change the pose.

To sum up, the device for image photographing provided in the embodiments of the disclosure obtains the preset pose for photographing and automatically photographs the image containing the target object if the pose of the target object in the preview image matches the preset pose for photographing, In this manner, the device can solve the problem that the user (i.e., the target object) has to make several attempts before obtaining a satisfactory image. In addition, the device can reduce the complexity of the user's operations. Meanwhile, by automatically photographing an image containing the target object, the device can solve the problem that the user's expression and pose might be affected when he manually snaps the shutter of the photographic device when manually photographing an image.

With respect to the devices in the above embodiments, the specific manners that the respective modules perform operations have been described in detail in the embodiments regarding the relevant methods, and will not be elaborated herein.

A device for image photographing is provided in an embodiment of the disclosure, which may implement the method for image photographing provided in the disclosure. The device includes: a processor; and a memory for storing instructions executable by the processor. The processor is configured to, when executing the instructions stored in the memory: obtain a preset pose for photographing; detect if a pose of a target object in a preview image matches the preset pose for photographing; and automatically photograph an image containing the target object, if the pose of the target object matches the preset pose for photographing.

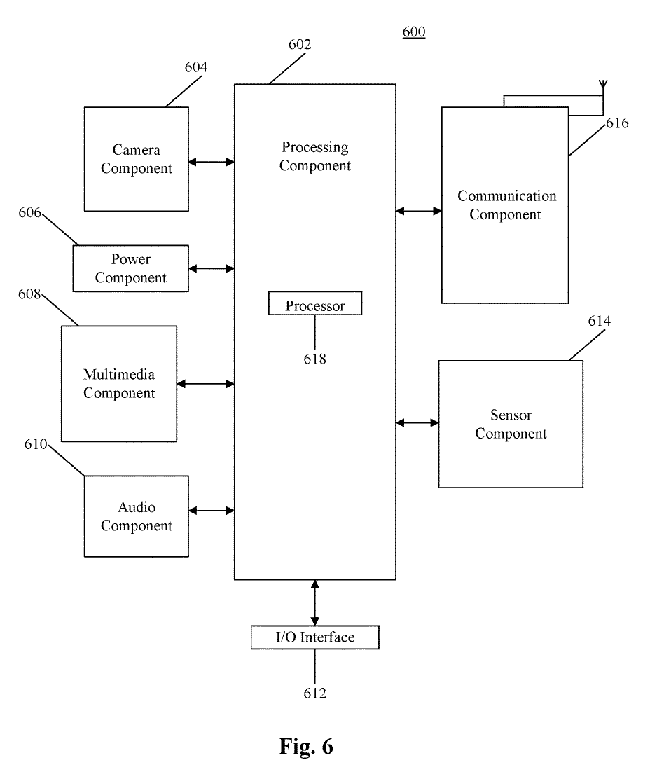

FIG. 6 is a block diagram of a device 600 for image photographing according to an exemplary embodiment. For example, the device 600 may be a mobile phone, a computer, a digital broadcast terminal, a messaging device, a gaming console, a tablet, a medical device, exercise equipment, a personal digital assistant, and the like.

Referring to FIG. 6, the device 600 may include one or more of the following components: a processing component 602, a camera component 604, a power component 606, a multimedia component 608, an audio component 610, an input/output (I/O) interface 612, a sensor component 614, and a communication component 616.

The processing component 602 typically controls overall operations of the device 600, such as the operations associated with display, telephone calls, data communications, camera operations, and recording operations. The processing component 602 may include one or more processors 618 to execute instructions to perform all or part of the steps in the above described methods. Moreover, the processing component 602 may include one or more modules which facilitate the interaction between the processing component 602 and other components. For instance, the processing component 602 may include a multimedia module to facilitate the interaction between the multimedia component 608 and the processing component 602.

The camera component 604 is configured to collect images. Such camera component 604 may be a component consisting of optical sensors.

The power component 606 provides power to various components of the device 600. The power component 606 may include a power management system, one or more power sources, and any other components associated with the generation, management, and distribution of power in the device 600.

The multimedia component 608 includes a screen providing an output interface between the device 600 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 608 includes a front camera and/or a rear camera. The front camera and the rear camera may receive an external multimedia datum while the device 600 is in an operation mode, such as a photographing mode or a video mode. Each of the front camera and the rear camera may be a fixed optical lens system or have focus and optical zoom capability.

The audio component 610 is configured to output and/or input audio signals. For example, the audio component 610 includes a microphone (“MIC”) configured to receive an external audio signal when the device 600 is in an operation mode, such as a call mode, a recording mode, and a voice recognition mode. The received audio signal may be further stored in the memory 604 or transmitted via the communication component 616. In some embodiments, the audio component 610 further includes a speaker to output audio signals.

The I/O interface 612 provides an interface between the processing component 602 and peripheral interface modules, such as a keyboard, a click wheel, buttons, and the like. The buttons may include, but are not limited to, a home button, a volume button, a starting button, and a locking button.

The sensor component 614 includes one or more sensors to provide status assessments of various aspects of the device 600. For instance, the sensor component 614 may detect an open/closed status of the device 600, relative positioning of components, e.g., the display and the keypad, of the device 600, a change in position of the device 600 or a component of the device 600, a presence or absence of user contact with the device 600, an orientation or an acceleration/deceleration of the device 600, and a change in temperature of the device 600. The sensor component 614 may include a proximity sensor configured to detect the presence of nearby objects without any physical contact. The sensor component 614 may also include a light sensor, such as a CMOS or CCD image sensor, for use in imaging applications. In some embodiments, the sensor component 614 may also include an accelerometer sensor, a gyroscope sensor, a magnetic sensor, a pressure sensor, or a temperature sensor.

The communication component 616 is configured to facilitate communication, wired or wirelessly, between the device 600 and other devices. The device 600 can access a wireless network based on a communication standard, such as WiFi, 2G, 3G, or 4G, or a combination thereof In one exemplary embodiment, the communication component 616 receives a broadcast signal or broadcast associated information from an external broadcast management system via a broadcast channel. In one exemplary embodiment, the communication component 616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 604, executable by the processor 618 in the device 600, for performing the above-described methods. For example, the non-transitory computer-readable storage medium may be a ROM, a random access memory (RAM), a CD-ROM, a magnetic tape, a floppy disc, an optical data storage device, and the like.

One of ordinary skill in the art will understand that the above described modules/units can each be implemented by hardware, or software, or a combination of hardware and software. One of ordinary skill in the art will also understand that multiple ones of the above described modules/units may be combined as one module/unit, and each of the above described modules/units may be further divided into a plurality of submodules/subunits.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof It is intended that the scope of the invention only be limited by the appended claims.

What is claimed is:

1. A method for image photographing, applied on a photographic device, comprising:
obtaining a preset pose for photographing;
detecting whether a pose of a target object in a preview image matches the preset pose for photographing; and
if the pose of the target object matches the preset pose for photographing, automatically photographing an image containing the target object.

2. The method of claim 1, wherein the obtaining the preset pose for photographing comprises:
receiving a pose setting signal and taking a pose set by the pose setting signal as the preset pose for photographing; or
obtaining the preset pose for photographing from a smart terminal, wherein the preset pose for photographing is a pose preset in the smart terminal.

3. The method of claim 1, further comprising:
determining whether the photographic device is in a horizontal state according to a gravity sensor; and
if the photographic device is in the horizontal state, automatically photographing the image containing the target object.

4. The method of claim 1, further comprising:
detecting whether the preview image satisfies preset conditions, wherein the preset conditions comprise at least one of a proportion of the target object in the preview image being greater than or equal to a preset proportion, or an area occupied by the target object in the preview image being a preset area; and
if the preview image satisfies the preset conditions, automatically photographing the image containing the target object.

5. The method of claim 1, wherein the automatically photographing the image containing the target object comprises:
issuing photographing prompt information; and
when a predetermined period of time has lapsed, automatically photographing the image containing the target object.

6. The method of claim 1, further comprising:
if the pose of the target object mismatches the preset pose for photographing, issuing voice prompt information for prompting the target object to change pose.

7. A device for image photographing, applied on a photographic device, comprising:
a processor; and
a memory for storing instructions executable by the processor;
wherein the processor is configured to, when executing the instructions stored in the memory:
obtain a preset pose for photographing;
detect whether a pose of a target object in a preview image matches the preset pose for photographing; and
if the pose of the target object matches the preset pose for photographing, automatically photograph an image containing the target object.

8. The device of claim 7, wherein the processor is further configured to:
receive a pose setting signal and take a pose set by the pose setting signal as the preset pose for photographing; or
obtain the preset pose for photographing from a smart terminal, wherein the preset pose for photographing is a pose preset in the smart terminal.

9. The device of claim 7, wherein the processor is further configured to:
determine whether the photographic device is in a horizontal state according to a gravity sensor; and
if the photographic device is in the horizontal state, automatically photograph the image containing the target object.

10. The device of claim 7, wherein the processor is configured to:
detect whether the preview image satisfies preset conditions, wherein the preset conditions comprise at least one of a proportion of the target object in the preview image being greater than or equal to a preset proportion, or an area occupied by the target object in the preview image being a preset area; and
if the preview image satisfies the preset conditions, automatically photograph the image containing the target object.

11. The device of claim 7, wherein the processor is further configured to:
issue photographing prompt information; and
when a predetermined period of time has lapsed, automatically photographing the image containing the target object.

12. The device of claim 7, wherein the processor is further configured to:
if the pose of the target object mismatches the preset pose for photographing, issue voice prompt information for prompting the target object to change pose.

13. A non-transitory computer-readable storage medium having stored therein instructions that, when executed by a processor, causes the processor to perform a method for image photographing, the method comprising:
obtaining a preset pose for photographing;
detecting whether a pose of a target object in a preview image matches the preset pose for photographing; and
if the pose of the target object matches the preset pose for photographing, automatically photographing an image containing the target object.
